(19) United States
(12) Patent Application Publication
(10) Pub. No.: US 2018/0366270 A1
(43) Pub. Date: Dec. 20, 2018

(54) DEVICES HAVING LOW INDUCTANCE AND METHODS OF MANUFACTURING THE SAME

(71) Applicant: General Electric Company, Schenectady, NY (US)

(72) Inventor: Ravisekhar Nadimpalli Raju, Clifton Park, NY (US)

(21) Appl. No.: 15/624,153

(22) Filed: Jun. 15, 2017

(51) Int. Cl. H01G 4/224; H01G 4/06; H01G 4/236; H01G 4/04

(52) U.S. Cl. CPC H01G 4/224; H01G 4/04; H01G 4/236; H01G 4/06

(57) ABSTRACT

A low inductance device includes a capacitor and an enclosure configured to enclose the capacitor, wherein the enclosure comprises an insulating material. The low inductance device also includes a conductive outer layer configured to surround at least a portion of an exterior surface of the enclosure.

### BACKGROUND

The subject matter disclosed herein relates to capacitors, and more specifically to apparatuses and methods to reduce inductance of a capacitor.

Capacitors are widely used in electric power conversion. For example, a power converter may include capacitor(s) in a direct current (DC)-link, in an alternating current (AC)-filter, and/or in a snubber circuit to dampen voltage spikes and reduce voltage overshoots across power semiconductors during switching. It may be desirable to use low-inductance capacitors in those applications, for reasons such as to achieve high frequency capability, low dissipation, etc. However, due to at least the construction and/or geometry, a capacitor may have an inductance (e.g., parasitic inductance) that may lead to undesirable effects, such as voltage overshoots and ringing.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a low inductance device includes a capacitor and an enclosure configured to enclose the capacitor, wherein the enclosure comprises an insulating material. The low inductance device also includes a conductive outer layer configured to surround at least a portion of an exterior surface of the enclosure.

In another embodiment, a capacitor includes capacitor components comprising conductive electrodes separated by one or more dielectric materials. The capacitor includes a first terminal and a second terminal coupled to the conductive electrodes to pass electrical current through the electrodes. The capacitor includes an enclosure configured to enclose the capacitor components and at least a portion of each of the first terminal and the second terminal, wherein the enclosure comprises an insulating material. The capacitor also includes a conductive outer layer configured to surround at least a portion of an exterior surface of the enclosure.

In another embodiment, a method of manufacturing a low-inductance device includes providing a device configured to be used as a capacitor, wherein the device comprises an insulating enclosure configured to enclose the device and at least a portion of a first terminal and a second terminal of the device configured to pass a current through the device. The method includes providing a conductive layer configured to surround at least a portion of an exterior surface of the insulating enclosure. The method also includes disposing the conductive layer on the exterior surface of the insulating enclosure.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an example of a modified capacitor having a low inductance, in accordance with embodiments of the present disclosure;

FIG. 2A-2C are perspective views of examples of modified capacitors having a low inductance, illustrating various shapes and geometries of the modified capacitor, in accordance with embodiments of the present disclosure; and

FIG. 3 is a flow chart illustrating a process for manufacturing a modified capacitor having a low inductance.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As set forth above, capacitors are used in many applications. For example, capacitors are used in power converters that may be based on wide-band-gap devices, such as silicon carbide (SiC) devices, gallium nitride (GaN) metal-oxide-semiconductor field-effect transistors (MOSFETs), etc. In those applications, it may be desirable to have the inductance of the capacitor be as low as possible to substantially reduce or eliminate the overvoltage (e.g., overvoltage, v(t) attributed to inductance combined with rapidly changing current or fast current switching; v(t)=Ld(i)/dt, wherein v denotes voltage, L denotes inductance, i denotes electrical current, and t denotes time). Accordingly, the present disclosure relates to apparatuses and methods to reduce inductance of a capacitor. In particular, the capacitor is modified to form a modified capacitor having a reduced inductance by including an electrically conductive outer layer to surround a partial or substantial portion of the exterior of the capacitor (e.g., exterior of an enclosure casing of the capacitor). The conductive outer layer may be in any suitable form (e.g., shell, housing, casing, paint, coating, sheet, tape, adhesive, foil, etc.) and configured to substantially formfit or conform to the shape of the partial or substantial portion of the exterior of the capacitor. As such, the conductive outer layer and internal current path(s) of the capacitor may form a mutual coupling that may lead to a net reduction of the inductance (e.g., parasitic inductance) of the modified capacitor.

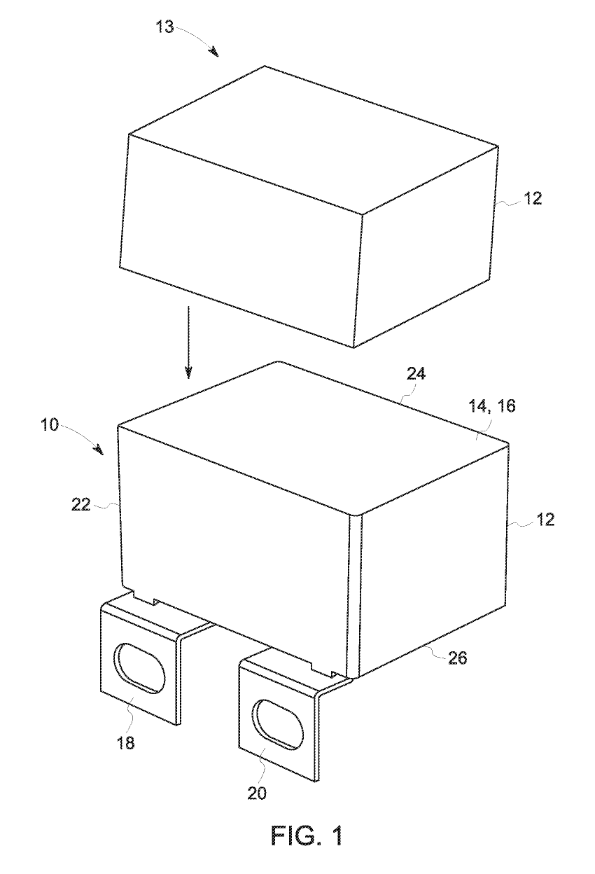

With the foregoing in mind, it may be useful to describe an embodiment of a capacitor 10 that may employ a conductive outer layer 12 to form a modified capacitor 13, as depicted in FIG. 1. The capacitor 10 (e.g., a capacitor used in a DC-link, a capacitor used in an AC-filter, or a snubber capacitor) includes an enclosure 14 (e.g., a housing, a casing, a capsule, etc.) having an exterior surface 16. The enclosure 14 may include any suitable insulating material, such as resin (e.g., polymerized resin), polymer, or plastic material, to enclose capacitor components (e.g., conductive electrodes separated by a dielectric material, such as polypropylene or other suitable material) among other things, in dry or wet construction (e.g., in suitable hardened resin or oil) in the capacitor 10. The capacitor 10 includes a first terminal 18 and a second terminal 20 configured to couple to the electrodes (e.g., directly or via any suitable mechanism) and conduct an electrical current (e.g., DC current or AC current) through the electrodes. It should be noted that the first and second terminals 18 and 20 may extend from the interior of the capacitor 10, through the enclosure 14, to the exterior of the capacitor 10. The enclosure 14 may be configured to enclose the capacitor components, among other things, with the first and second terminals 18 and 20 protruding out of the enclosure 14. The enclosure 14 may be an air-tight enclosure, a liquid-tight enclosure, or both.

The modified capacitor 13 includes the conductive outer layer 12 disposed on the capacitor 10 to surround or cover at least a portion (e.g., a partial or substantial portion) of the exterior surface 16 of the enclosure 14. In the illustrated embodiment, the exterior surface 16 includes side surface(s) 22, a top surface 24, and a bottom surface 26, and the conductive outer layer 12 includes a conductive copper (or copper alloy) shell configured to substantially formfit the capacitor 10 to surround or cover the top surface 24 and the side surfaces 22. In other embodiments, the conductive outer layer 12 may comprise any suitable electrically conductive material, such as conductive polymer, metal, metal alloy, or a combination thereof. The conductive outer layer 12 may be in the form of a shell, housing, casing, paint, coating, sheet, tape, adhesive, foil, etc., configured to substantially formfit and/or conform to the shape of the capacitor 10 to surround or cover at least a portion of the exterior surface 16. The conductive outer layer 12 may be disposed on the capacitor 10 via any suitable method, such as formfitting, adhering (e.g., via conductive glue or adhesive), wrapping, painted-on, brushed-on, deposited-on, etc. The conductive outer layer 12 may be configured to surround or cover a portion or all of the top surface 24, the bottom surface 26, the side surface(s) 22, or any combination thereof. For example, the conductive outer layer 12 may be configured to surround or cover all of the top surface 24, all of the side surface(s) 22, and a portion or all of the bottom surface 26.

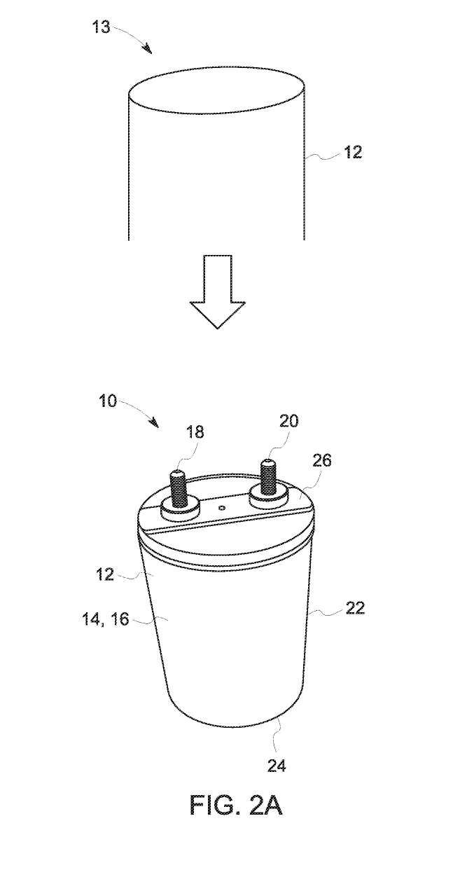

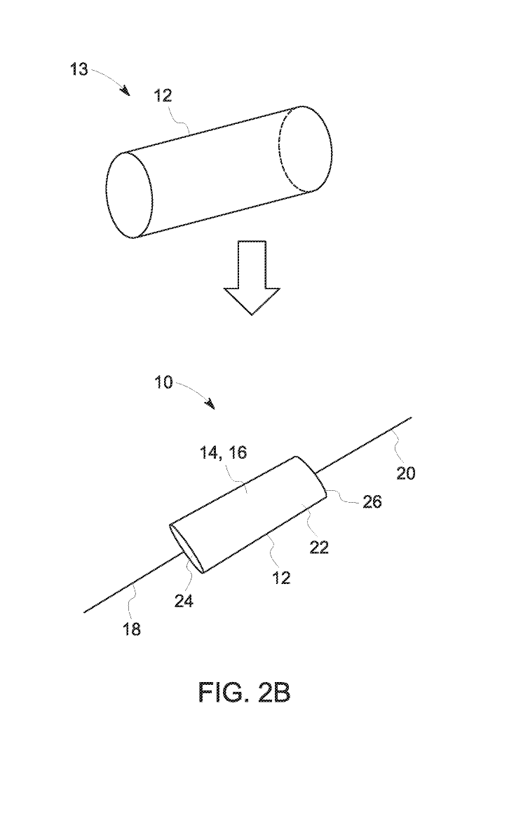

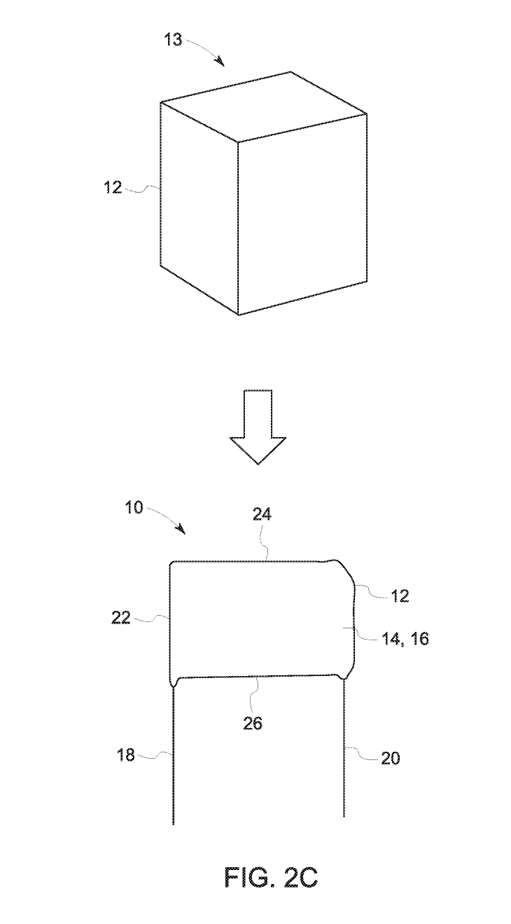

It should be noted that the capacitor 10 may have any suitable shapes/geometries (e.g., cylinder, box, irregularly shaped, etc.), sizes, and capacitance range. For example, FIGS. 2A, 2B, and 2C each provides a perspective view of embodiments of the capacitor 10 that may employ the conductive outer layer 12. While the capacitor 10 shown in FIG. 1 is generally rectangular or cubical in shape, the capacitor 10 shown in FIGS. 2A and 2B are generally cylindrical in shape, and the capacitor 10 shown in FIG. 2C is irregular in shape. In addition, the capacitor 10 may have the first and second terminals 18 and 20 disposed on the same side or surface (e.g., the bottom surface 26) as shown in FIG. 1, FIG. 2A, and FIG. 2C, or the capacitor 10 may have the first and second terminals 18 and 20 disposed on different and/or opposite sides or surfaces (e.g., the top surface 24 and the bottom surface 26) as shown in FIG. 2B. Correspondingly, the conductive outer layer 12 in the form of a shell or the like may be configured to substantially formfit the shape of the capacitor 10 to surround or cover at least a portion of the exterior surface 16 of the enclosure 14. Alternatively or cumulatively, the conductive outer layer 12 in the form of paint or the like may be applied on the capacitor 10 to substantially conform to the shape of at least a portion of the exterior surface 16.

The conductive outer layer 12 and the internal current path of the capacitor 10 may form a mutual coupling that results in a net reduction of the parasitic inductance of the modified capacitor 13. In certain embodiments, the net reduction of the parasitic inductance attributed to the presence of the conductive outer layer 12 may be about 30% reduction. For example, the modified capacitor 13 (e.g., a snubber capacitor) wrapped with the conductive outer layer 12 comprising a copper foil may show a reduction of the parasitic inductance from about 20 nano Henry (nH) to about 14 nH. As may be appreciated, the conductive outer layer 12 may be used in combination with other suitable ways to reduce parasitic inductance, such as paralleling multiple capacitors or using low profile geometries.

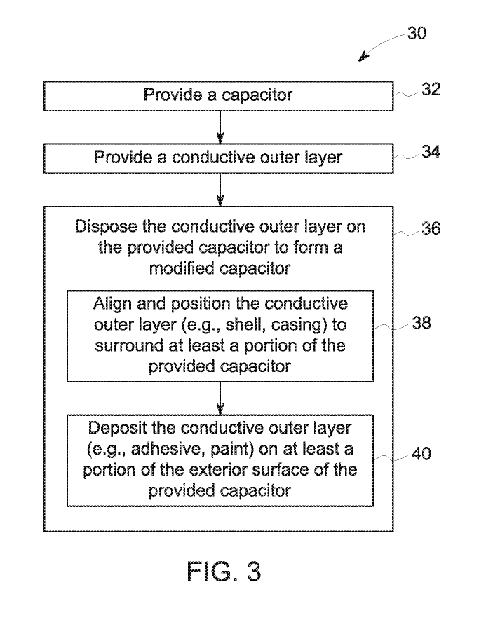

FIG. 3 is a flow chart illustrating a process 30 for manufacturing the modified capacitor 13, in accordance with embodiments of the present disclosure. The process 30 may include providing a capacitor (e.g., the capacitor 10) (block 32). For example, providing a capacitor may include manufacturing, fabricating, or purchasing the capacitor 10 (e.g., a capacitor suitable to be used a DC-link, a capacitor suitable to be used an AC-filter, a snubber capacitor, etc.). The process 30 may include providing a conductive outer layer (e.g., the conductive outer layer 12) (block 34). For example, providing a conductive outer layer may include manufacturing, fabricating, or purchasing the conductive outer layer 12. As set forth above, the conductive outer layer 12 may comprise any suitable electrically conductive material, such as conductive polymer, metal, metal alloy, or a combination thereof. The conductive outer layer 12 may be in the form of a shell, housing, casing, paint, coating, sheet, tape, adhesive, foil, etc., configured to substantially formfit and/or conform to the shape of the capacitor 10 to surround or cover at least a portion of the capacitor (e.g., exterior surface 16 of the capacitor 10).

The process 30 may include disposing the conductive outer layer 12 on the provided capacitor (e.g., the capacitor 10) to form a modified capacitor (e.g., the modified capacitor 13) having a reduced inductance (with respect to the capacitor 10) (block 36). For example, disposing the conductive outer layer may include aligning and positioning the conductive outer layer 12 (in the form of shell, housing, casing, etc.) on the capacitor 10 to substantially formfit and surround or cover at least a portion of the capacitor 10 (e.g., with or without disposing a conductive adhesive/glue between the capacitor 10 and the conductive outer layer 12) (block 38). For example, disposing the conductive outer layer may include depositing the conductive outer layer 12 (in the form of paint, adhesive, foil, tape, etc.) on the capacitor 10 to substantially conform to and cover at least a portion of the capacitor 10 (block 40). In some embodiments, the conductive outer layer 12 may surround or cover substantially the entire exterior surface 16 of the enclosure 14. In some embodiments, the conductive outer layer 12 may surround or cover the top surface 24, the side surface(s) 22, the bottom surface 26, or a combination thereof. As such, the conductive outer layer 12 and the internal current path of the capacitor 10 may form a mutual coupling that results in a net reduction of the parasitic inductance of the modified capacitor 13.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A low inductance device, comprising:
a capacitor;
an enclosure configured to enclose the capacitor, wherein the enclosure comprises an insulating material; and
a conductive outer layer configured to surround at least a portion of an exterior surface of the enclosure.

2. The low inductance device of claim 1, wherein the exterior surface comprises a top surface, a bottom surface, and one or more side surfaces, wherein the top and bottom surfaces are opposite to one another and the one or more side surfaces are directly adjacent to the top surface and the bottom surface.

3. The low inductance device of claim 2, wherein the conductive outer layer is configured to substantially surround the top surface and the one or more side surfaces of the exterior surface of the enclosure.

4. The low inductance device of claim 1, wherein the conductive outer layer is configured to substantially formfit at least a portion of the enclosure.

5. The low inductance device of claim 1, wherein the conductive outer layer is configured to substantially conform to the shape of at least a portion of the enclosure.

6. The low inductance device of claim 1, wherein the insulating material comprises a plastic material, a polymer, a resin, or a combination thereof.

7. The low inductance device of claim 1, wherein the conductive outer layer comprises copper or copper-based alloy.

8. A capacitor, comprising:
capacitor components comprising conductive electrodes separated by one or more dielectric materials;
a first terminal and a second terminal coupled to the conductive electrodes to pass electrical current through the electrodes;
an enclosure configured to enclose the capacitor components and at least a portion of each of the first terminal and the second terminal, wherein the enclosure comprises an insulating material; and
a conductive outer layer configured to surround at least a portion of an exterior surface of the enclosure.

9. The capacitor of claim 8, wherein the exterior surface comprises a top surface, a bottom surface, and one or more side surfaces, wherein the top and bottom surfaces are opposite to one another and the one or more side surfaces are directly adjacent to the top surface and the bottom surface.

10. The capacitor of claim 9, wherein the conductive outer layer is configured to substantially surround the top surface and the one or more side surfaces of the exterior surface of the enclosure.

11. The capacitor of claim 8, wherein the conductive outer layer comprises a shell or a casing to substantially formfit at least a portion of the enclosure.

12. The capacitor of claim 8, wherein the conductive outer layer comprises an adhesive or paint deposited on at least a portion of the enclosure to substantially conform to the shape of the enclosure.

13. The capacitor of claim 8, comprising a snubber capacitor, a capacitor of a direct current (DC)-link, or a capacitor of an alternative current (AC)-filter.

14. The capacitor of claim 8, comprising hardened resin or oil disposed between between the capacitor components and the enclosure.

15. A method of manufacturing a low-inductance device comprising:
providing a device configured to be used as a capacitor, wherein the device comprises an insulating enclosure configured to enclose the device and at least a portion of a first terminal and a second terminal of the device configured to pass a current through the device;
providing a conductive layer configured to surround at least a portion of an exterior surface of the insulating enclosure; and
disposing the conductive layer on the exterior surface of the insulating enclosure.

16. The method of claim 15, wherein providing the conductive layer comprises providing a conductive shell that is configured to substantially formfit at least a portion of the enclosure.

17. The method of claim 16, wherein disposing the conductive layer comprises aligning and positioning the conductive shell on the at least a portion of the enclosure.

18. The method of claim 15, wherein providing the conductive layer comprises providing a conductive adhesive.

19. The method of claim 18, wherein disposing the conductive layer comprises depositing the conductive adhesive on the exterior surface of the enclosure.
